(19) United States
(12) Patent Application Publication
(10) Pub. No.: US 2013/0203330 A1
(43) Pub. Date: Aug. 8, 2013

(54) INFORMATION REPORTING SYSTEM FOR COIN-OPERATED DEVICE

(71) Applicant: Tze-Tsai SHEN, Taipei (TW)

(72) Inventor: Tze-Tsai SHEN, Taipei (TW)

(21) Appl. No.: 13/432,867

(22) Filed: Mar. 28, 2012

(30) Foreign Application Priority Data
Feb. 7, 2012 (TW) 101202219

(51) Int. Cl. G07D 9/00; H04W 8/00; G06F 15/16

(52) U.S. Cl. 453/58

(57) ABSTRACT

An information reporting system for a coin-operated device includes a sensing device, an embedded system, and a communication module. The sensing device generates a sensing value according to a coin feeding status. The embedded system reads the sensing value and generates a data packet. The communication module sends the data packet according to a contact information to report the coin feeding status of the coin-operated device to a system user. The information reporting system for a coin-operated device reports the coin feeding status of the coin-operated device to the system user in real time and allows the system user to know the coin feeding status with a remote device and determine the best time to fetch coins from the coin-operated device, thereby cutting commuting costs incurred by the system user.

### BACKGROUND OF THE INVENTION

1. Technical Field

The present invention relates to information reporting systems for coin-operated devices, and more particularly, to an information reporting system configured for use with a coin-operated device and for reporting the coin feeding status of the coin-operated device to a system user in real time.

2. Description of Related Art

Technological advancement is accompanied by ever-increasing ease of trade. Foy example, the emergence of convenience stores discourages people from buying the necessities of life at specialty stores or warehouse stores. Convenient retail channels make shopping faster. Small necessities, such as bottled and canned drinks, snacks, newspapers, etc., are sold at coin-operated devices on sidewalks. Shops which do business with coin-operated game machines, coin-operated washers, or coin-operated dryers are ubiquitous in downtowns. As indicated above, coin-operated devices have wide application. Coin-operated devices not only allow consumers to gain access to goods quickly and conveniently, but also simplify coin-operated device attendants' jobs. Although a coin-operated device offers a shorter list of goods than a convenience store, it is self-contained and automated, thereby cutting labor costs.

Although coin-operated device attendants need not take care of coin-operated devices around the clock, the attendants have to remove coins from a coin-operated device before the coins therein accumulate to such an extent to clog a coin channel of the coin-operated device. Clogging the coin channel with coins usually ends up with a stuck coin or the malfunctioning coin-operated device. In general, the best time for coin removal is the point in time when the coin storage capacity of the coin-operated device is reached. However, it is impossible for the attendants to predict the point in time at which the coin storage capacity of coin-operated devices is reached. Hence, the attendants visit coin-operated devices regularly in order to ensure that the coin-operated devices will not malfunction for reaching the coin storage capacity thereof. The visits to the coin-operated devices incur commuting costs and take time.

Accordingly, it is imperative to enable coin-operated device attendants to cut commuting costs by informing the attendants of the time to collect coins from coin-operated devices.

### SUMMARY OF THE INVENTION

The present invention provides an information reporting system for a coin-operated device. The information reporting system comprises a sensing device, an embedded system, and a communication module. After receiving a data packet from the embedded system, the communication module sends the data packet to a system user to allow the system user to know the coin feeding status of a coin-operated device in real time and determine the best time to fetch coins from the coin-operated device, thereby cutting commuting costs incurred by the system user.

The present invention provides an information reporting system for a coin-operated device, configured to report a coin feeding status of the coin-operated device, the information reporting system comprising: a sensing device for sensing the coin feeding status and generating a sensing value; an embedded system in signal communication with the sensing device, the embedded system comprising: a memory for storing at least one alarming value and an apparatus ID; and a central processing unit for reading the sensing value, generating a status information, and sending a data packet carrying the apparatus ID and the status information; and a communication module being in signal communication with the embedded system and configured with at least one contact information to receive the data packet and send the data packet according to the contact information.

Implementation of the present invention at least involves the following inventive steps:

1. Informing coin-operated device attendants of the coin feeding status of a coin-operated device in real time.

2. Cutting commuting costs incurred by coin-operated device attendants.

3. Evaluating the appeal of a coin-operated device to customers in terms of location according to data reported by the coin-operated device.

Hereinafter, the detailed features and advantages of the present invention are described in detail by way of the preferred embodiments of the present invention so as to enable persons skilled in the art to gain insight into the technical disclosure of the present invention, implement the present invention accordingly, and readily understand the objectives and advantages of the present invention by making reference to the disclosure of the specification, the claims, and the drawings of the present invention.

### BRIEF DESCRIPTION OF THE DRAWINGS

FIG. 1 is a schematic view of an information reporting system for a coin-operated device according to an embodiment of the present invention;

FIG. 2 is another schematic view of the information reporting system for a coin-operated device according to an embodiment of the present invention;

FIG. 3 is a block diagram of a circuit of the information reporting system according to an embodiment of the present invention;

FIG. 4A is a flow chart of comparing a sensing value and an alarming value according to an embodiment of the present invention;

FIG. 4B is another flow chart of comparing a sensing value and an alarming value according to an embodiment of the present invention; and

FIG. 5 is a flow chart of the information reporting system for a coin-operated device according to an embodiment of the present invention.

### DETAILED DESCRIPTION OF THE INVENTION

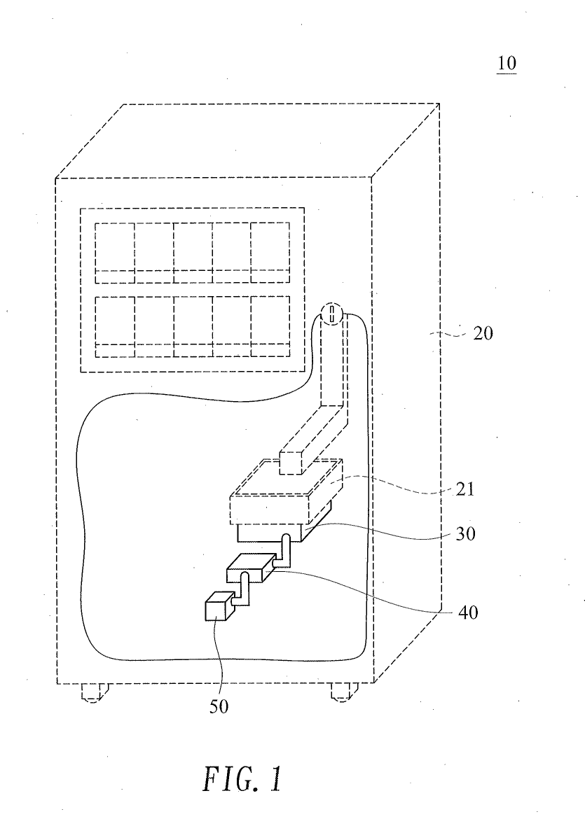

Referring to FIG. 1, in this embodiment, an information reporting system 10 for a coin-operated device 20 is disposed in the coin-operated device 20 and adapted to report the coin feeding status of the coin-operated device 20 to a system user. The coin-operated device 20 is a vending machine, a parking meter, or a ticket vending machine. The information reporting system 10 comprises a sensing device 30, an embedded system 40, and a communication module 50.

The sensing device 30 senses the coin :feeding status of the coin-operated device 20 and generates a sensing value according to the coin feeding status thus sensed. The sensing device 30 is a weight sensor and is coupled to a coin container 21 of the coin-operated device 20 from below, such that the weight sensor can sense the weight of the coin container 21 and generate the sensing value of an analog signal; meanwhile, the sensing value equals the weight value of the coin container 21.

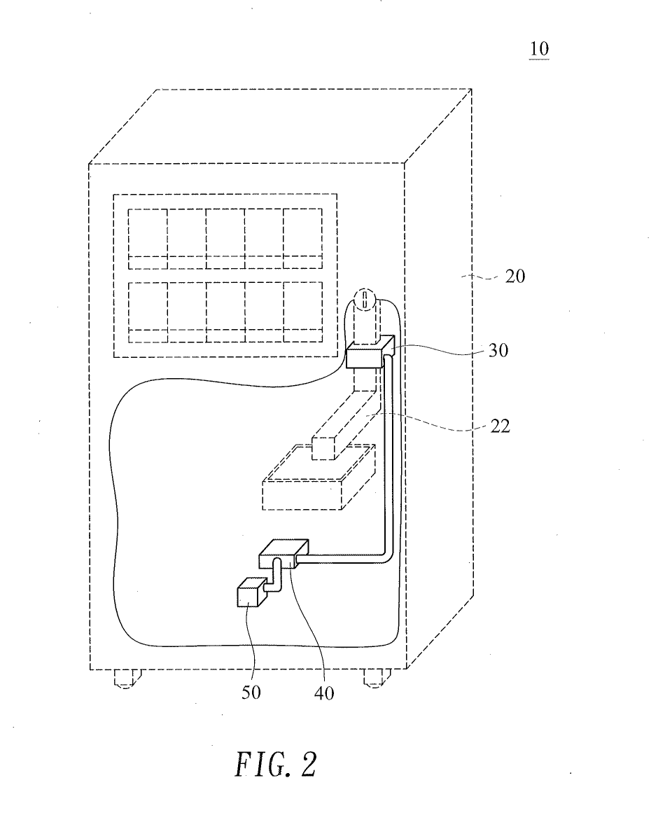

Referring to FIG. 2, the sensing device 30 is a counter or an electronic coin feeding sensor, and is coupled to a coin channel 22 of the coin-operated device 20. When the sensing device 30 is the counter, coins fed to the coin-operated device 20 pass through the coin channel 22, and then the counter senses the quantity of the coins to generate a sensing value equal to a quantity value. When the sensing device 30 is the electronic coin feeding sensor, the electronic coin feeding sensor detects the quantity and the respective monetary values of the coins by pulses, and the sensing value equals the total monetary value.

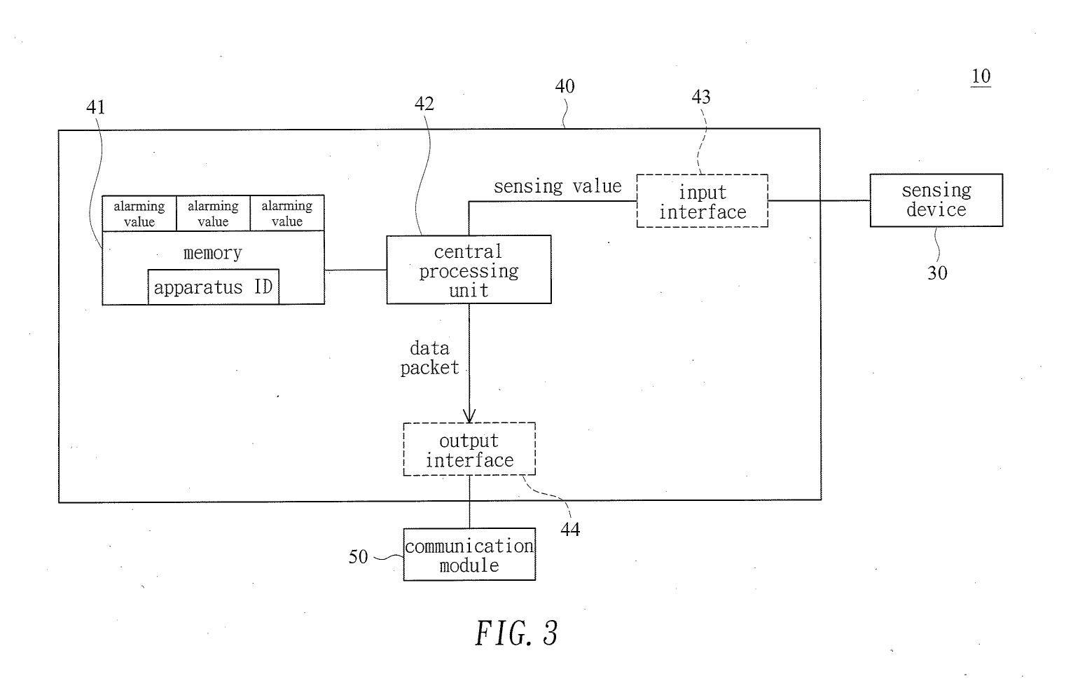

Referring to FIG. 3, the embedded system 40 is in signal communication with the sensing device 30 via a data transmission line and is adapted to read the sensing value generated from the sensing device 30. The embedded system 40 comprises a memory 41 and a central processing unit 42. The memory 41 stores at least one alarming value and an apparatus ID beforehand. The alarming value equals a value preset by the system user and assigned to the embedded system 40 such that, afterward, the alarming value is compared with the sensing value generated from the sensing device 30 (to be further described below). The apparatus ID is each ID preset in the coin-operated device 20 or the sensing device 30 and recognized by the system user.

The central processing unit 42 reads, through at least one input interface 43, the sensing value generated from the sensing device 30, and generates a status information. The status information is generated, after the central processing unit 42 has read the alarming value from the memory 41 and compared the sensing value with the alarming value. Alternatively, the central processing unit 42 generates the status information according to the sensing value at preset points in time without comparing the sensing value with the alarming value.

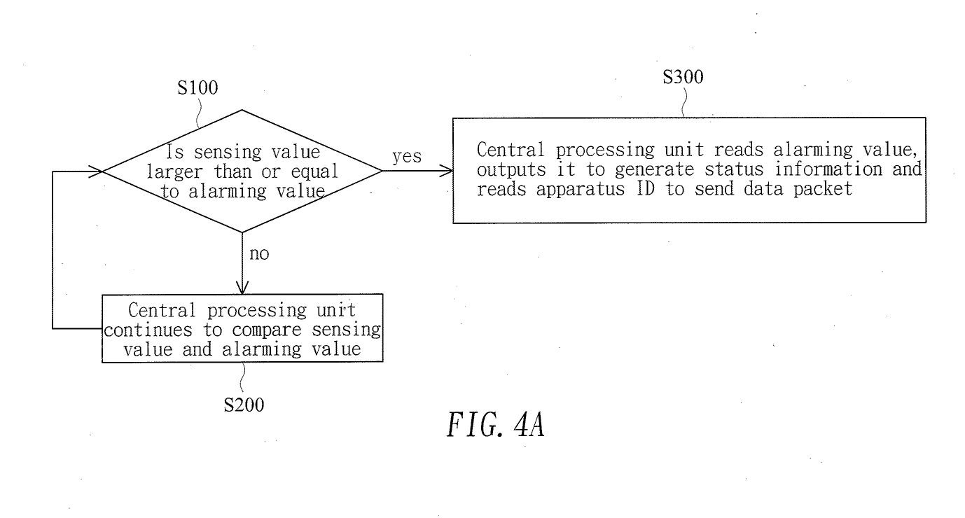

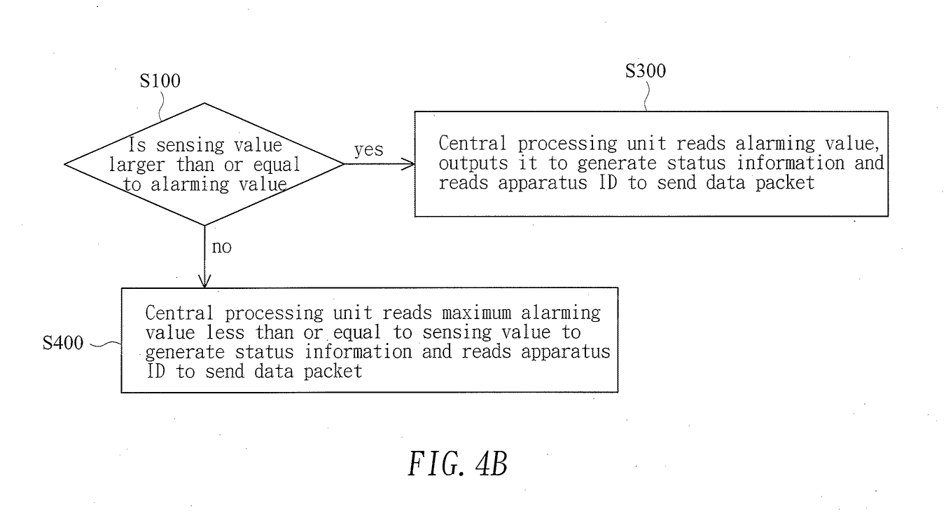

Referring to FIG. 3 and FIG. 4A, for example, the central processing unit 42 reads the sensing value repeatedly and compares the sensing value with the alarming value repeatedly. However, if the sensing value is less than the alarming value, the central processing unit 42 will continue comparing the sensing value and the alarming value (step S200) until the sensing value is larger than or equal to the alarming value (step S100); and only if the sensing value is larger than or equal to the alarming value, will the central processing unit 42 generate the status information according to the alarming value, read the apparatus ID from the memory 41, and send a data packet carrying the status information and the apparatus ID (step S300). Furthermore, the central processing unit 42 sends the data packet to the communication module 50 via at least one output interface 44. That is to say, the central processing unit 42 will generate and send the data packet, only if the sensing value reaches or exceeds the preset alarming value.

Referring to FIG. 3 and FIG. 4B, it is also feasible that the central processing unit 42 compares the sensing value and the alarming value periodically. For example, the memory 41 is configured with a plurality of points in time beforehand, and the central processing unit 42 reads the sensing value and compares the sensing value with the alarming value as soon as one of the points in time comes. If the result of comparison indicates that the sensing value is larger than or equal to the alarming value (step S100), the central processing unit 42 will read the alarming value to generate the status information and read the apparatus ID from the memory 41, so as to send the status information and the apparatus ID in the form of the data packet (step S300) to the communication module 50 via the at least one output interface 44. If one of the points in time comes and the sensing value is less than the alarming value, the central processing unit 42 will read the maximum alarming value less than or equal to the current sensing value to generate ate the status information and read the apparatus ID from the memory 41 to send the data packet (step S400) to the communication module 50 via the at least one output interface 44.

For example, if the memory 41 is configured with the alarming value of 20 and the central processing unit 42 reads the sensing value of 30 generated from the sensing device 30 at a specific point in time (i.e., the sensing value of 30 is larger than the alarming value of 20), the central processing unit 42 will read the alarming value of 20 to generate the status information and send to the communication module 50 the data packet carrying the status information and the apparatus ID from the memory 41. If the memory 41 is configured with the alarming values of 20 and 40 and the central processing unit 42 reads the sensing value of 35 at another point in time (i.e., the sensing value of 35 is less than the alarming value 40), the central processing unit 42 will read the maximum alarming value less than or equal to the sensing value of 35, that is, the alarming value of 20, to generate the status information and send to the communication module 50 the data packet carrying the status information and the apparatus ID from the memory 41. Since the status information is generated periodically, the system user is informed of the coin feeding status of the coin-operated device 20 at a preset point in time according to the data packet reported and thus can determine which said coin-operated device 20 to visit and collect coins therefrom according to the apparatus ID.

It is also feasible that the central processing unit 42 is configured to send the sensing value read at a plurality of points in time directly so as to generate the status information periodically, and then send to the system user the data packet carrying the apparatus ID and the status information so as to let the system user know the sensing value of the coin-operated device 20 at the preset points in time according the data packet reported.

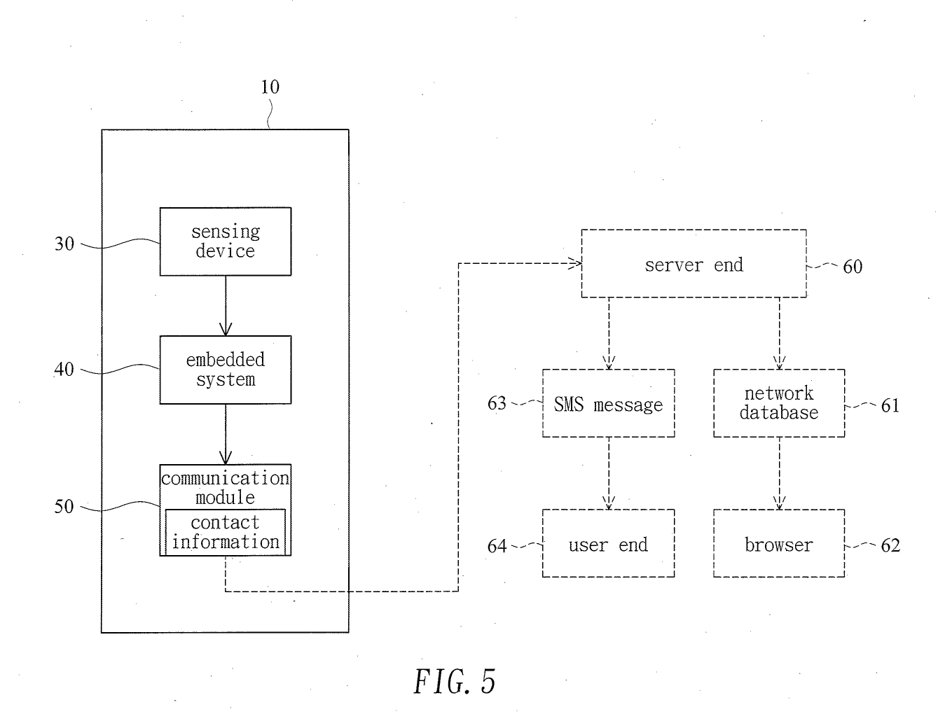

Referring to FIG. 5, the communication module 50 is in signal communication with the embedded system 40 via a data transmission line, and receives the data packet from the embedded system 40. The communication module 50 is configured with at least one contact information. The communication module 50 sends the data packet to a server end 60 according to the contact information. When the communication module 50 is a cable network module or a wireless network module, the contact information is an email address or an IP address; meanwhile, after receiving the data packet, the communication module 50 sends the data packet to the server end 60. Then, the server end 60 sends the data packet to a network database 61 according to the contact information, such that the system user can gain access to the contents of the data packet online through a browser 62. When the communication module 50 is a wireless communication module, the contact information is a mobile phone number; meanwhile, after receiving the data packet, the communication module 50 sends the data packet to the server end 60. Then, the server end 60 sends the data packet to a cell phone at a user end 64 according to the contact information by means of an SIMS message 63, such that the user end 64 is informed of the status of the coin-operated device 20 in real time.

In conclusion, an information reporting system 10 of the present invention enables a system user to manage a coin-operated device 20 better, compares a sensing value and an alarming value, and takes the initiative in informing the system user of the coin feeding status of the coin-operated device 20 in real time so as to enable the system user to determine the best time to visit the coin-operated device 20 and collect coins therefrom and thereby reduce commuting costs and time. Furthermore, the information reporting system of the present invention enables the system user to evaluate the appeal of the coin-operated device 20 to customers in terms of location according to the reported coin feeding status of the coin-operated device 20.

The features of the present invention are disclosed above by the preferred embodiments to allow persons skilled in the art to gain insight into the contents of the present invention and implement the present invention accordingly. The preferred embodiments of the present invention should not be interpreted as restrictive of the scope of the present invention. Hence, all equivalent modifications or amendments made to the aforesaid embodiments should fall within the scope of the appended claims.

What is claimed is:

1. An information reporting system for a coin-operated device, configured to report a coin feeding status of the coin-operated device, the information reporting system comprising:
a sensing device for sensing the coin feeding status and generating a sensing value;
an embedded system in signal communication with the sensing device, the embedded system comprising:
a memory for storing at least one alarming value and an apparatus ID; and
a central processing unit for reading the sensing value, generating a status information, and sending a data packet carrying the apparatus ID and the status information; and
a communication module being in signal communication with the embedded system and configured with at least one contact information to receive the data packet and send the data packet according to the contact information.

2. The information reporting system of claim 1, wherein the sensing device is a weight sensor coupled to a coin container of the coin-operated device from below.

3. The information reporting system of claim 1, wherein the sensing device is a counter or an electronic coin feeding sensor and is coupled to a coin channel of the coin-operated device.

4. The information reporting system of claim 1, wherein the central processing unit compares the sensing value and the alarming value to generate the status information, whereas the data packet will be generated and sent only if the sensing value is larger than or equal to the alarming value.

5. The information reporting system of claim 4, wherein the central processing unit compares the sensing value and the alarming value periodically.

6. The information reporting system of claim 1, wherein, after reading the sensing value, the central processing unit generates the status information and sends the data packet periodically.

7. The information reporting system of claim 1, wherein the communication module is a cable network module, and the contact information is an email address or an IP address.

8. The information reporting system of claim 1, wherein the communication module is a wireless network module, and the contact information is an email address or an IP address.

9. The information reporting system of claim 1, wherein the communication module is a wireless communication module, and the contact information is a mobile phone number.
